(19) United States
(12) Patent Application Publication
(10) Pub. No.: US 2025/0231030 A1
(43) Pub. Date: Jul. 17, 2025

(54) MODEL GENERATION DEVICE, ROUTE SUGGESTION DEVICE, MODEL GENERATION METHOD, AND RECORDING MEDIUM

(71) Applicant: NEC Corporation, Minato-ku, Tokyo (JP)

(72) Inventor: Shinji Nakadai, Tokyo (JP)

(73) Assignee: NEC Corporation, Minato-ku, Tokyo (JP)

(21) Appl. No.: 18/853,849

(22) PCT Filed: May 9, 2022
(86) PCT No.: PCT/JP2022/019664

§ 371 Date: Oct. 3, 2024

(51) Int. Cl. G01C 21/20

(52) U.S. Cl. CPC G01C 21/20

(57) ABSTRACT

In a model generation device, a proposed route generation means generates and outputs a suggested route indicating a traveling route of a moving object. An evaluation acquisition means acquires an evaluation of a user for the suggested route. A training data generation means generates training data using the evaluation of the user which is acquired. A model generation means generates a route evaluation model indicating a relationship between the traveling route and the evaluation of the user, using the training data.

### TECHNICAL FIELD

The present disclosure relates to a technique for evaluating a route of a moving object.

### BACKGROUND ART

In recent years, the use of a drone for a variety of applications has been considered. Operation methods for the drone include a technique called an IFR (Instrument Flight Rules) in which drones are flown according to each instruction from an air traffic controller, and a technique called a VFR (Visual Flight Rules) in which the drone is flown while a pilot visually recognizes other aircrafts, and other techniques. Patent Document 1 describes a device for setting a flight route of an unmanned aircraft based on a departure point and an arrival point.

### PRECEDING TECHNICAL REFERENCES

### Patent Document

Patent Document 1: Japanese Laid-open Patent Publication No. 2019-39875

### SUMMARY

### Problem to be Solved by the Invention

It is preferable for a pilot of a VER to register a flight plan, but it is not

possible to register the flight plan during drone maneuvers. Moreover, in the VFR, a drone is basically flown at a decision of the pilot, but it is desirable for an external system to suggest a flight route and other information to the pilot as an assistant, thereby enhancing flight safety. In this case, the external system is preferably able to suggest the flight route and other information suitable for the pilot, based on characteristics such as those related to the operation of the pilot.

It is one object of the present disclosure to enable an evaluation of a traveling route according to characteristics of an operator of a moving object.

### Means for Solving the Problem

According to an example aspect of the present disclosure, there is provided a model generation device including:
a proposed route generation means configured to generate and output a suggested route indicating a traveling route of a moving object;
an evaluation acquisition means configured to acquire an evaluation of a user for the suggested route;
a training data generation means configured to generate training data using the evaluation of the user which is acquired; and
a model generation means configured to generate a route evaluation model indicating a relationship between the traveling route and the evaluation of the user, using the training data.

According to another example aspect of the present disclosure, there is provided a model generation method including:
generating and outputting a suggested route indicating a traveling route of a moving object;
acquiring an evaluation of a user for the suggested route;
generating training data using the evaluation of the user which is acquired; and
generating a route evaluation model indicating a relationship between the traveling route and the evaluation of the user, using the training data.

According to a further example aspect of the present disclosure, there is provided a recording medium storing a program, the program causing a computer to perform a process including:
generating and outputting a suggested route indicating a traveling route of a moving object;
acquiring an evaluation of a user for the suggested route;
generating training data using the evaluation of the user which is acquired; and
generating a route evaluation model indicating a relationship between the traveling route and the evaluation of the user, using the training data.

### Effect of the Invention

According to the present disclosure, it becomes possible to evaluate a traveling route according to characteristics of an operator of a moving object.

### BRIEF DESCRIPTION OF THE DRAWINGS

FIG. 1 illustrates a configuration of a drone flight system according to a first example embodiment.

FIG. 2 is a block diagram illustrating a hardware configuration of an operation device.

FIG. 3 is a block diagram illustrating a hardware configuration of a route presentation device.

FIG. 4 is a block diagram illustrating respective functional configurations of the operation device and the route suggestion device.

FIG. 5 illustrates an example of an operation screen.

FIG. 6 is a flowchart of a training process of a route evaluation model by the route suggestion device.

FIG. 7 is a flowchart of the route suggestion process using the route evaluation model which is trained.

FIG. 8 is a block diagram illustrating a functional configuration of a model generation device of a second example embodiment.

FIG. 9 is a flowchart of a process by the model generation device of the second example embodiment.

### EXAMPLE EMBODIMENTS

In the following, example embodiments will be described with reference to the accompanying drawings.

### First Example Embodiment

### Overall Configuration

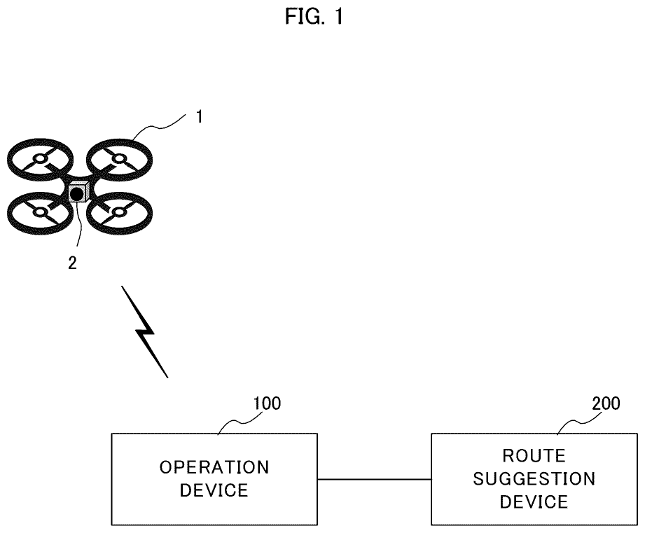

FIG. 1 illustrates a configuration of a drone flight system according to a first example embodiment. The drone flight system is a system for flying a drone 1 to a destination under a control of a pilot, and includes an operation device 100 and a route suggestion device 200.

The operation device 100 is operated by the pilot to fly the drone 1 by wirelessly transmitting a control signal to the drone 1. The drone 1 includes a camera 2. The drone 1 captures images at least in a traveling direction of the drone 1 by the camera 2, and wirelessly transmits the captured images to the operation device 100. The pilot operates the drone I while watching an operation screen displayed based on the captured images in the traveling direction of the drone 1.

The route suggestion device 200 suggests a flight route of the drone 1. Specifically, the route suggestion device 200 generates a route (hereinafter, also referred to as a “suggested route”) for the drone 1 to fly, based on a flight plan of the drone 1, and transmits the suggested route to the operation device 100. The pilot who operates the operation device 100 controls the drone 1 in consideration of the suggested route received from the route suggestion device 200, and also evaluates the suggested route. An evaluation which is input by the pilot for the suggested route is transmitted to the route suggestion device 200. The route suggestion device 200 acquires the evaluation of the pilot for the suggested route, and learns a relationship between the suggested route and the evaluation of the pilot for the suggested route, so that the route suitable for the pilot can be proposed.

### Hardware Configuration

### Operation Device

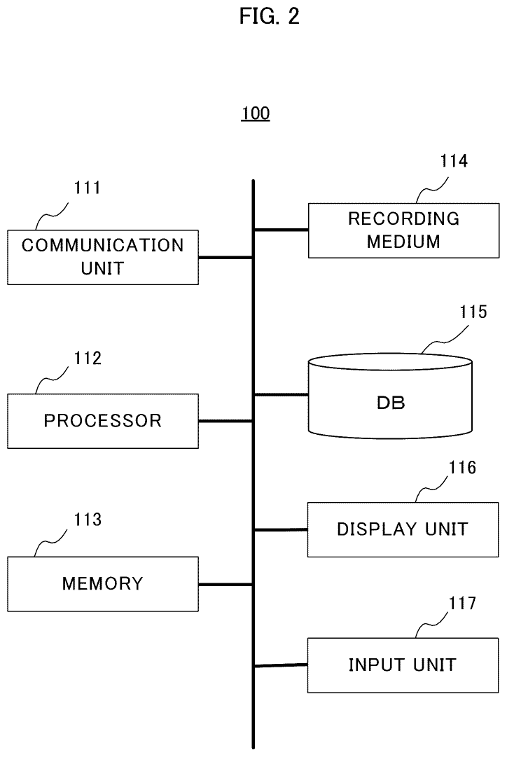

FIG. 2 is a block diagram illustrating a hardware configuration of the operation device 100. As illustrated in FIG. 2, the operation device 100 includes a communication unit 111, a processor 112, a memory 113, a recording medium 114, a database (DB) 115, a display unit 116, and an input unit 117.

The communication unit 111 transmits and receives data to and from an external device. Specifically, the operation device 100 transmits the control signal for the flight of the drone 1 to the drone 1 through the communication unit 111, and receives the captured images of the camera 2 from the drone 1. Moreover, the operation device 100 receives the suggested route from the route suggestion device 200 through the communication unit 111, and transmits the evaluation of the pilot for the suggested route to the route suggestion device 200.

The processor 112 is a computer such as a CPU (Central Processing Unit), and controls the entire operation device 100 by executing programs prepared in advance. The processor 112 may be a GPU (Graphics Processing Unit), a TPU (Tensor Processing Unit), a quantum processor or a FPGA (Field-Programmable Gate Array).

The memory 113 is formed by a ROM (Read Only Memory), a RAM (Random Access Memory), and the like. The memory 113 is also used as a working memory during executions of various processes by the processor 112.

The recording medium 114 is a non-volatile and non-transitory recording medium such as a disk-shaped recording medium or a semiconductor memory, and is formed to be detachable from the operation device 100. The recording medium 114 records various programs to be executed by the processor 112. In a case where the operation device 100 performs various processes, the programs recorded on the recording medium 114 are loaded into the memory 113 and executed by the processor 112.

The DB 115 stores data to be used by the operation device 100 and data generated by the operation device 100. Specifically, the DB 115 stores the captured images of the camera 2 which is transmitted from the drone 1, the suggested route which is transmitted from the route suggestion device 200, and the like. Moreover, the DB 115 stores the evaluation which is input by the pilot, for the suggested route. Furthermore, the DB 115 stores various types of information necessary for the pilot to remotely control the drone 1 using the operation device 100.

The display unit 116 is, for example, a liquid crystal display device, and displays the captured images transmitted from the drone 1 for the pilot. Moreover, information concerning the suggested route transmitted from the route suggestion device 200 is displayed on the display unit 116. The input unit 117 is, for example, an input device such as a joystick or various buttons, or a voice input device including a microphone, and is used by the pilot to provide necessary instructions and inputs while controlling the drone 1.

### Route Suggestion Device

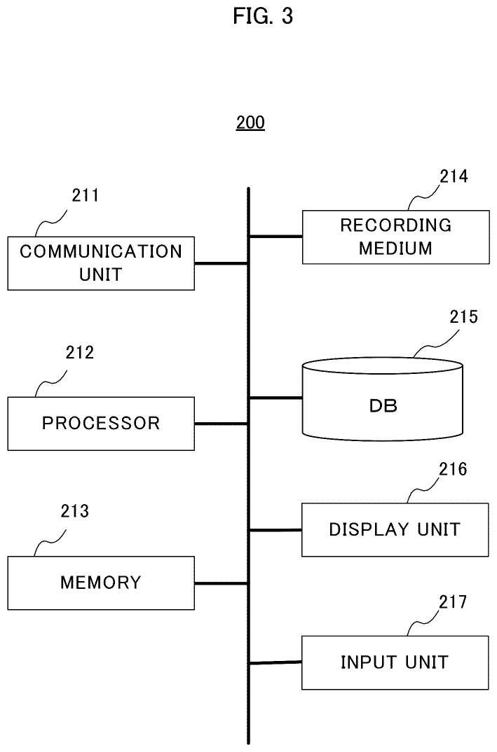

FIG. 3 is a block diagram illustrating a hardware configuration of the route suggestion device 200. As illustrated, the route suggestion device 200 includes a communication unit 211, a processor 212, a memory 213, a recording medium 214, a DB 215, a display unit 216, and an input unit 217.

The communication unit 211 transmits and receives data to and from an external device. Specifically, through the communication unit 211, the suggested route is transmitted to the operation device 100 and the evaluation of the pilot is received from the operation device 100.

The processor 212 is a computer such as a CPU, and controls the entire route suggestion device 200 by executing programs prepared in advance. Note that the processor 212 may be a GPU, a TPU, a quantum processor, or a FPGA. The processor 212 executes a training process of a route evaluation model and a route suggestion process using the route evaluation model, as will be described later.

The memory 213 is formed by a ROM, a RAM, and the like. The memory 213 is also used as a working memory during executions of various processes by the processor 212.

The recording medium 214 is a non-volatile and non-temporary recording medium such as a disk-shaped recording medium or a semiconductor memory, and is formed to be detachable from the route suggestion device 200. The recording medium 214 records various programs executed by the processor 212. In a case where the route suggestion device 200 executes the various processes, the programs recorded on the recording medium 214 are loaded into the memory 213 and executed by the processor 212.

The DB 215 stores data used by the route suggestion device 200 and data generated by the route suggestion device 200. Specifically, the DB 215 stores a plurality of suggested routes generated by the route suggestion device 200 and the evaluation of the pilot for the suggested route transmitted from the operation device 100. Moreover, the DB 215 stores training data for generating the route evaluation model, the generated route evaluation model, and the like.

The display unit 216 is, for example, a liquid crystal display device, and displays the generated suggested route or the like as necessary. The input unit 117 is an input device such as a keyboard, a mouse, or the like, and is used by an operator to perform necessary instructions and inputs in the training process or the route suggestion process of the route evaluation model.

### Functional Configurations

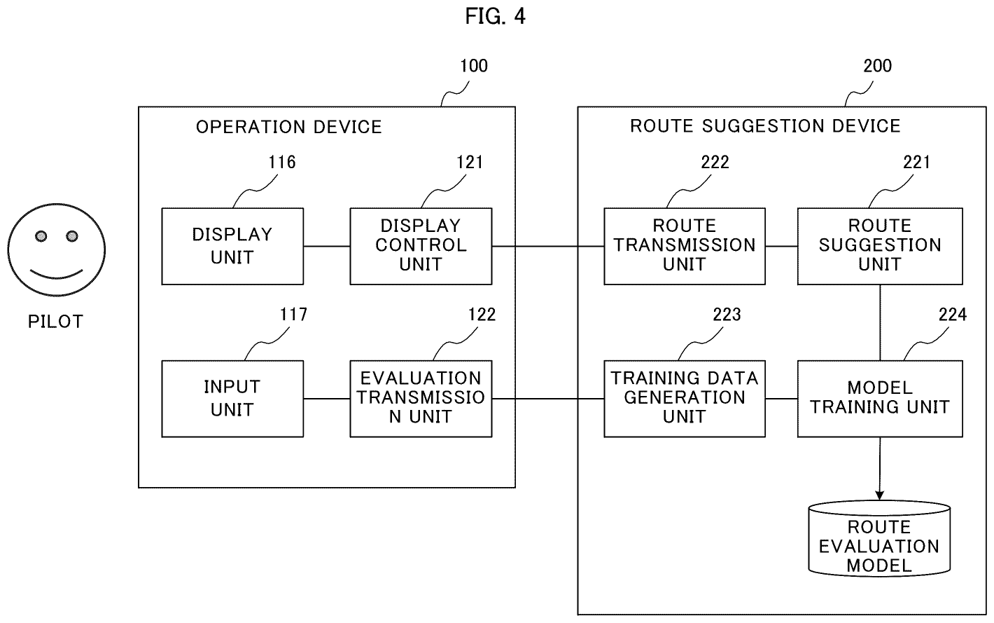

Next, functional configurations of the operation device 100 and the route suggestion device 200 will be described. FIG. 4 is a block diagram illustrating the functional configurations of the operation device 100 and the route suggestion device 200. As illustrated, the operation device 100 includes a display control unit 121 and an evaluation transmission unit 122 in addition to the display unit 116 and the input unit 117 described above.

On the other hand, the route suggestion device 200 includes a route suggestion unit 221, a route transmission unit 222, a training data generation unit 223, and a model training unit 224. Note that the route suggestion unit 221 and the route transmission unit 222 are examples of a suggested route generation means, the training data generation unit 223 is an example of an evaluation acquisition means and a training data generation means, and the model training unit 224 is an example of a model generation means.

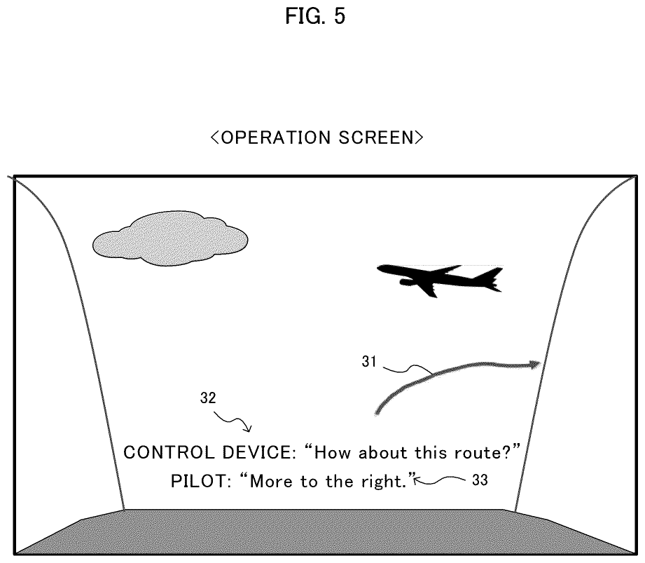

First, the operation device 100 will be described. The display control unit 121 controls a display in the display unit 116. Specifically, the display control unit 121 generates an operation screen by using the captured images transmitted from the drone 1, and displays the captured images on the display unit 116. FIG. 5 illustrates an example of the operation screen. In the example in FIG. 5, an image on the operation screen mimics a view from a cockpit. On the operation screen, each of the captured images received from the drone 1 are displayed in Augmented Reality (AR). Since the operation screen is generated based on each of the captured images transmitted from the drone 1, the operation screen is updated as the drone 1 moves.

Moreover, information concerning the suggested route transmitted from the route suggestion device 200 is superimposed and displayed on the operation screen. In the example in FIG. 5, information (arrow) 31 indicating a traveling direction of the drone 1 along the suggested route is displayed. In addition, a message 32 requesting the evaluation of the pilot regarding the suggested route is transmitted from the route suggestion device 200 as necessary, and is displayed on the operation screen. The pilot reviews the information 31 of the traveling direction along the suggested route and the message 32, understands the suggested route by the route suggestion device 200, and inputs the evaluation for the suggested route. In the example in FIG. 5, the pilot responds “More to the right” by voice input to the information 31 representing the traveling direction. Although FIG. 5 illustrates “More to the right” as a response of the pilot for convenience of explanation, the response of the pilot does not actually have to be displayed on the operation screen. In addition, instead of voice input, the pilot may use the aforementioned joystick or other means to input an instruction to modify the traveling direction as the evaluation of the suggested route.

The input unit 117 acquires the evaluation of the pilot for a guide route, which is input using the voice input or the joystick, and outputs the evaluation to the evaluation transmission unit 122. The evaluation transmission unit 122 transmits the evaluation of the pilot to the route suggestion device 200. Specifically, in a case where the pilot inputs the evaluation by the voice input, the evaluation transmission unit 122 may transmit the input voice as it is to the route suggestion device 200, or may analyze contents of the voice and transmit the contents to the route suggestion device 200 as information indicating that “correction to the right is necessary”. Moreover, in a case where the pilot inputs the evaluation using the joystick, the evaluation transmission unit 122 transmits data indicating an operation direction of the joystick, an operation volume, an operation duration, and the like to the route suggestion device 200. Thus, the evaluation of the pilot for the route suggestion is sent to the route suggestion device 200.

Next, the route suggestion device 200 will be described. The route suggestion unit 221 generates the suggested route based on the flight plan specified by the pilot or the like. The flight plan may include at least departure and destination of the drone, and may further include airframe information of the drone flying. The route suggestion unit 221 generates, for example, a flight route in which the departure and destination are connected by a straight line on a map, or a route in which a skyscraper, a mountain area, and the like are avoided in consideration of topographical information as the suggested route. Incidentally, in addition to the airframe information of the drone, the route suggestion unit 221 may generate the suggested route in consideration of environment information, such as weather information in a planned flight zone at a time of planning the flight for the drone, topographical information of the planned flight zone, and the like. Moreover, the route suggestion unit 221 may generate the suggested route using a route generation model which is prepared in advance and is based on AI (Artificial Intelligence). The route suggestion unit 221 outputs the generated suggested route to the route transmission unit 222.

The route transmission unit 222 transmits the suggested route generated by the route suggestion unit 221 to the operation device 100. In the operation device 100, as described above, the display control unit 121 receives the suggested route and displays information 31 of the traveling direction along the suggested route and the like on the operation screen.

The training data generation unit 223 receives the evaluation of the pilot transmitted from the operation device 100, and generates training data for the training of the route evaluation model. The route evaluation model is a model to evaluate the suggested route considering characteristics of each pilot, and also is a model in which a relationship between the suggested route presented to the pilot and the evaluation of the pilot for the suggested route is learned. That is, the route evaluation model generated for a pilot A predicts, and outputs the evaluation of the pilot A for the suggested route in response to an input of the suggested route.

The training data corresponds to data in which the suggested route is used as input data and the evaluation of the pilot for the suggested route is used as correct answer data. Here, the evaluation of the pilot is a value in which the evaluation input by the pilot to the operation device 100 is digitalized by some method. For example, the training data generation unit 223 may assign a maximum evaluation value if the pilot performs a positive evaluation once, and may assign a lower evaluation value the greater the number of times the pilot repeatedly performs a negative evaluation, for the suggested route being presented. Specifically, the training data generation unit 223 may set the evaluation value based on the number of times the pilot has performed negative evaluation (instruction of correction) on the voice input or the number of times the pilot has input the instruction of correction by the joystick. Alternatively, the training data generation unit 223 may determine, as the evaluation value, a degree of whether or not the evaluation for the suggested route is positive by analyzing contents of the evaluation in response to the voice input of the evaluation by the pilot. The training data generation unit 223 outputs the generated training data to the model training unit 224.

The model training unit 224 trains the route evaluation model using the training data, and generates the route evaluation model. The route evaluation model thus obtained outputs an evaluation close to perception of each pilot for the suggested route which is input.

### Training Process

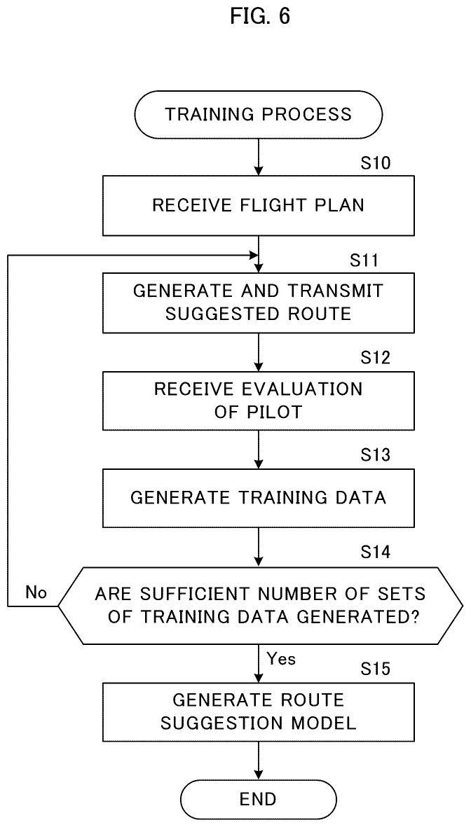

FIG. 6 is a flowchart of the training process of the route evaluation model by the route suggestion device 200. This training process is realized by the processor 212 illustrated in FIG. 3 executing programs prepared in advance and operating as respective elements of the route suggestion device 200 illustrated in FIG. 4.

First, the route suggestion unit 221 receives the flight plan of the drone (step S10). The flight plan includes at least the departure and destination of the drone. The route suggestion unit 221 generates the suggested route of the drone to the destination based on the flight plan, and transmits the suggested route to the operation device 100 (step S11). The suggested route is presented to the pilot at the operation device 100, and the pilot inputs the evaluation for the suggested route. The evaluation of the pilot is transmitted from the operation device 100 to the route suggestion device 200.

In response to receiving the evaluation of the pilot from the operation device 100 (step S12), the training data generation unit 223 digitizes the evaluation of the pilot, and generates training data in which the obtained evaluation value is the correct answer data (step S13). The training data are output to the model training unit 224. Next, the model training unit 224 determines whether or not a sufficient number of sets of training data are generated (step S14). If the sufficient number of sets of training data have not been generated (step S14: No), this process returns to step S11, and steps S11 to S14 are repeated until the sufficient number of training data are generated. On the other hand, if the sufficient number of sets of training data have been generated (step S14: Yes), the model training unit 224 trains the route evaluation model using the sufficient number of sets of training data, and generates the route evaluation model (step S15). Then, the training process is terminated. The training process is not limited to generating the route evaluation model first, and may be performed periodically as re-training of the existing route evaluation model.

### Route Suggestion Process

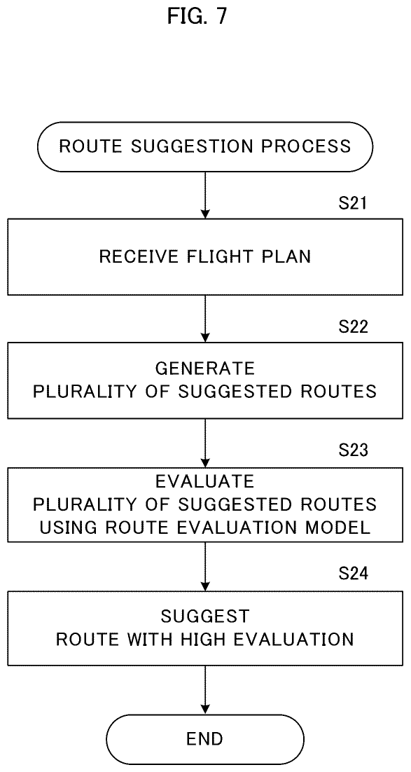

Next, an example of a method of suggesting a route to the pilot using the route evaluation model generated by training will be described. FIG. 7 is a flowchart of the route suggestion process using the trained route evaluation model. This route suggestion process is realized by the processor 212 illustrated in FIG. 3 executing programs prepared in advance and mainly operating as the route suggestion unit 221 illustrated in FIG. 4.

First, the route suggestion unit 221 receives the flight plan of the drone (step S21). Next, the route suggestion unit 221 generates a plurality of suggested routes to the destination based on the flight plan (step S22). Next, the route suggestion unit 221 evaluates the plurality of suggested routes being generated, using the trained route evaluation model (step S23). Specifically, the route suggestion unit 221 inputs the plurality of suggested routes which are generated to the trained route evaluation model, and acquires evaluation values respective to the plurality of suggested routes. Next, the route suggestion unit 221 transmits one or more suggested routes with high evaluation values output by the route evaluation model from among the plurality of suggested routes to the operation device 100 through the route transmission unit 222 (step S24). Accordingly, it is possible for the route suggestion device 200 to propose a route which is more adapted to the characteristics of each pilot for the flight plan.

### Modification

In the above example embodiment, the present disclosure is applied to the suggestion of the traveling route of the drone; however, the application of the present disclosure is not limited to this example embodiment. The present disclosure can be similarly applied to various moving objects which move according to a predetermined route, such as automobiles, automated guided vehicles used in factories and warehouses, and the like.

### Second Example Embodiment

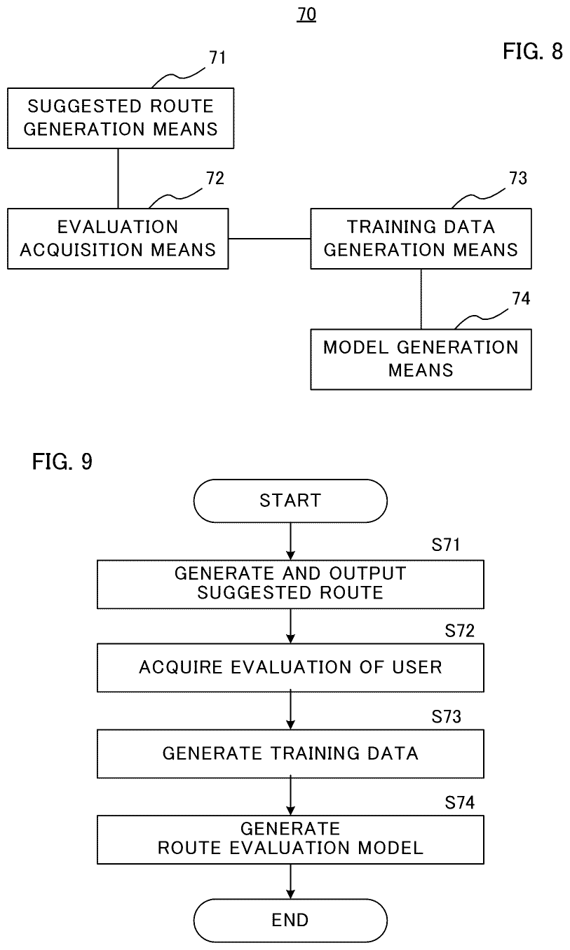

FIG. 8 is a block diagram illustrating a functional configuration of a model generation device 70 according to the second example embodiment. The model generation device 70 includes a suggested route generation means 71, an evaluation acquiring means 72, a training data generation means 73, and a model generation means 74.

FIG. 9 is a flowchart of a process performed by the model generation device 70 according to the second example embodiment. The suggested route generation means 71 generates a suggested route indicating the traveling route of the moving object, and outputs the generated suggested route (step S71). The evaluation acquisition means 72 acquires the evaluation of the user for the suggested route (step S72). The training data generation means 73 generates the training data using the evaluation acquired from the user (step S73). The model generation means 74 generates the route evaluation model which indicates the relationship between the travel route and the evaluation of the user, using the training data (step S74).

According to the model generation device 70 of the second example embodiment, the route evaluation model is generated that enables the suggested route to be evaluated in consideration of the characteristics of the pilot.

A part or all of the example embodiments described above may also be described as the following supplementary notes, but not limited thereto.

### Supplementary Note 1

A model generation device comprising:
a proposed route generation means configured to generate and output a suggested route indicating a traveling route of a moving object;
an evaluation acquisition means configured to acquire an evaluation of a user for the suggested route;
a training data generation means configured to generate training data using the evaluation of the user which is acquired; and
a model generation means configured to generate a route evaluation model indicating a relationship between the traveling route and the evaluation of the user, using the training data.

### Supplementary Note 2

The model generation device according to supplementary note 1, wherein the proposed route generation means outputs information indicating a traveling direction of the moving object with reference to a current location of the moving object, to an operation device which the user uses to operate the moving object.

### Supplementary Note 3

The model generation device according to supplementary note 2, wherein the evaluation acquisition means acquires the evaluation of the user for the traveling direction of the moving object from the operation device.

### Supplementary Note 4

The model generation device according to supplementary note 1, wherein the training data generation means generates the training data by digitalizing the evaluation of the user which is acquired.

### Supplementary Note 5

A route suggestion device comprising:
a flight plan acquisition means configured to acquire a flight plan including at least a departure and a destination of the moving object from the user;
a suggested route generation means configured to generate a plurality of suggested routes based on the flight plan;
an evaluation result output means configured to evaluate the plurality of suggested routes using the route evaluation model generated by the model generation device according to supplementary note 1, and output each evaluation result; and
an output configured to select and output at least one suggested route based on each evaluation result.

### Supplementary Note 6

A model generation method comprising:
generating and outputting a suggested route indicating a traveling route of a moving object;
acquiring an evaluation of a user for the suggested route;
generating training data using the evaluation of the user which is acquired; and
generating a route evaluation model indicating a relationship between the traveling route and the evaluation of the user, using the training data.

### Supplementary Note 7

A recording medium storing a program, the program causing a computer to perform a process comprising:
generating and outputting a suggested route indicating a traveling route of a moving object;
acquiring an evaluation of a user for the suggested route;
generating training data using the evaluation of the user which is acquired; and
generating a route evaluation model indicating a relationship between the traveling route and the evaluation of the user, using the training data.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

1 Drone
2 Camera
112, 212 Processor
121 Display control unit
122 Evaluation transmission unit
221 Route suggestion unit
222 Route transmission unit
223 Training data generation unit
224 Model training unit
100 Operation device
200 Route suggestion device

What is claimed is:

1. A model generation device comprising:
at least one memory configured to store instructions; and
at least one processor configured to execute the instructions to:
generate and output a suggested route indicating a traveling route of a moving object;
acquire an evaluation of a user for the suggested route;
generate training data using the evaluation of the user which is acquired; and
generate a route evaluation model indicating a relationship between the traveling route and the evaluation of the user, using the training data.

2. The model generation device according to claim 1, wherein the processor outputs information indicating a traveling direction of the moving object with reference to a current location of the moving object, to an operation device which the user uses to operate the moving object.

3. The model generation device according to claim 2, wherein the processor acquires the evaluation of the user for the traveling direction of the moving object from the operation device.

4. The model generation device according to claim 1, wherein the processor generates the training data by digitalizing the evaluation of the user which is acquired.

5. A route suggestion device comprising:
at least one memory configured to store instructions; and
at least one processor configured to execute the instructions to:
acquire a flight plan including at least a departure and a destination of the moving object from the user;
generate a plurality of suggested routes based on the flight plan;
evaluate the plurality of suggested routes using the route evaluation model generated by the model generation device according to claim 1, and output each evaluation result; and
select and output at least one suggested route based on each evaluation result.

6. A model generation method performed by a computer and comprising:
generating and outputting a suggested route indicating a traveling route of a moving object;
acquiring an evaluation of a user for the suggested route;
generating training data using the evaluation of the user which is acquired; and
generating a route evaluation model indicating a relationship between the traveling route and the evaluation of the user, using the training data.

7. A non-transitory computer-readable_recording medium storing a program, the program causing a computer to perform a process comprising:
generating and outputting a suggested route indicating a traveling route of a moving object;
acquiring an evaluation of a user for the suggested route;
generating training data using the evaluation of the user which is acquired; and
generating a route evaluation model indicating a relationship between the traveling route and the evaluation of the user, using the training data.
